(19) United States
(12) Patent Application Publication
(10) Pub. No.: US 2017/0028683 A1
(43) Pub. Date: Feb. 2, 2017

(54) RESIN-METAL COMPOSITE COMPRISING ADHESIVE LAYER

(71) Applicant: WAPS. CO. LTD, Busan (KR)

(72) Inventors: Jung Seong HA, Gyeongsangnam-do (KR); Hyun Jin KIM, Seoul (KR); Young Hoon KANG, Chungcheongbuk-do (KR)

(21) Appl. No.: 15/113,238

(22) PCT Filed: Feb. 12, 2014
(86) PCT No.: PCT/KR2014/001162

§ 371 Date: Jul. 21, 2016

(30) Foreign Application Priority Data
Jan. 22, 2014 (KR) 10-2014-0007806

(51) Int. Cl. B32B 15/085; B32B 3/26; B32B 27/20; B32B 27/08; B32B 27/32; B32B 27/30; B32B 7/12; B32B 15/18

(52) U.S. Cl. CPC B32B 15/085; B32B 7/12; B32B 3/263; B32B 15/18; B32B 27/08; B32B 27/32; B32B 27/308; B32B 27/20; B32B 2250/03; B32B 2307/306; B32B 2307/558; B32B 2607/00; E04F 13/16

(57) ABSTRACT

The provided is a metal-resin composite with high shock resistance, thermal shock resistance and adhesion, which comprises an adhesive layer comprising at least one of copolymers and terpolymers between the metal layer and the resin layer. The adhesive layer comprises at least one of copolymers and terpolymers obtained from a copolymerization of two or three of the following monomers a), b), c) and d): a) an α-olefin represented by the Chemical Formula 1: RCH═CH₂ (where R is a hydrogen or an alkyl radical of 1 to 8 carbon atoms); b) at least one of acrylate or methacrylate; c) at least one of α,β-ethylenated unsaturated acrylic acid and methacrylic acid each of which has 3 to 20 carbon atoms, sulfonic acid, and phosphoric acid; and d) a monomer having any one of glycidyl group, hydroxyl group, anhydrous maleic acid group, carboxylic acid group, and ester group.

### TECHNICAL FIELD

The present invention relates to a metal-resin composite comprising an adhesive layer, and more specifically, to a metal-resin composite of high shock resistance, thermal shock resistance and adhesion comprising an adhesive layer between metal and resin layers, wherein the adhesive layer comprises at least one of copolymers and terpolymers obtained from a copolymerization of two or three of the following monomers a), b), c) and d):

a) an α-olefin represented by Chemical Formula 1 below,

RCH═CH₂ [Chemical Formula 1]

wherein R is a hydrogen or an alkyl radical having 1 to 8 carbon atoms;

b) at least one of acrylate and methacrylate; c) at least one of α,β-ethylenated unsaturated acrylic acid and methacrylic acid each of which has 3 to 20 carbon atoms, sulfonic acid, and phosphoric acid; and d) a monomer comprising any one of glycidyl group, hydroxyl group, anhydrous maleic acid group, carboxylic acid group, and ester group.

### TECHNICAL BACKGROUND

Building materials are classified into structural and design materials according to their intended use. Structural materials require high mechanical strength and durability as they are used to build the frames of a building. In particular, structural materials require properties regarding constructional abilities, long-term use, weight, workability, local corrosion resistance and fire resistance, and should not cause any structural problems such as deformation or fracture on entire outer walls of a building.

The structural materials include stone, brick, wood, steel, concrete and the like. Among them, the stone and brick are also used as finishing materials.

Stone has high durability, wear resistance and rigidity, and has been traditionally used as a structural material, but requires a lot of efforts for processing with some disadvantages such as difficulties in handling and low workability. Thus, recently stone is more used as an interior finishing material due to its unique characteristics.

Brick has high workability, structural strength, durability, fire resistance, and productivity, and is often used as a structural or interior decoration material. When brick is used as a structural material, it has good resistance to vertical load, but weak resistance to horizontal load, and thus it is inappropriate to use in earthquake-prone regions, and especially for high-rise buildings.

Wood has high rigidity against specific gravity, and good workability, and is used as a structural or finishing material, depending on its directional properties. However, wood shows significantly low corrosion resistance and fire resistance, depending on application areas.

Another widely used structural material is concrete which is made by mixing cement, sand and gravel with water and curing the mixture. Concrete has high fire resistance and durability, and is used to enhance the strength of structures together with steel bars and frames. However, concrete has high specific gravity, and requires the use of formwork to form structures, incurring great expense. In addition, concrete requires the use of water, and is vulnerable to external conditions during the construction period, and takes a long time to complete a structure.

To resolve those problems found in such traditional building materials, various materials are recently being developed. Especially, demands for wood with high stability, lightness and magnificent appearance in civil engineering continue to occur, and Wood Plastic Composite (hereinafter referred to as “WPC”), a profile extrusion product made by mixing wood and plastic, is very popular as an exterior building material.

WPC is prepared by adding wood powder to various thermo-plastic resins such as polyethylene and polypropylene, and has the combined benefit of an excellent workability of plastic and a magnificent appearance of wood. Furthermore, it has higher rigidity, more competitive price, and higher applicability than a single material of wood or plastic, and is being used in many fields, including exterior building material, fence, car body, interior decoration, and signboard. Recently, a technology of manufacturing metal-resin laminates by coextruding WPC on the metal surface was introduced to lighten WPC, and to improve mechanical properties thereof, including flexural rigidity.

A metal-resin laminate is light and excellent in heat insulation, fire resistance, and mechanical properties, but if used as an exterior building material, cracks are caused by delamination between metal and resin layers if physical impact is applied thereto, and also caused by thermal shock from temperature changes due to the difference of thermal conductivity between metal and resin layers.

Therefore, for the use of metal-resin laminates as an exterior material, a building material with high shock resistance and thermal shock resistance is still required.

### SUMMARY

The purpose of the present invention is to solve the above problems, and to provide a metal-resin composite of high shock resistance, thermal shock resistance and adhesion, wherein the composite comprises an adhesive layer comprising at least one of copolymers and terpolymers between metal and resin layers.

The present invention also aims to provide a metal-resin composite of high uniformity and durability by combining both resin and adhesive layers simultaneously with extrusion using a dual extruder with two slits.

The above purpose is achieved by a metal-resin composite comprising a metal layer, a resin layer and an adhesive layer between the metal and resin layers, wherein an adhesive composition for the adhesive layer comprises at least one of copolymers and terpolymers obtained from a copolymerization of two or three of the following monomers a), b), c) and d):

a) an α-olefin represented by the following Chemical Formula 1,

[Chemical Formula 1]

RCH═CH₂ (wherein R is a hydrogen or an alkyl radical of 1 to 8 carbon atoms); b) at least one of acrylate and methacrylate; c) at least one of α,β-ethylenated unsaturated acrylic acid and methacrylic acid each of which has 3 to 20 carbon atoms, sulfonic acid, and phosphoric acid; and d) a monomer having any one of glycidyl group, hydroxyl group, anhydrous maleic acid group, carboxylic acid group, and ester group.

The monomer c) may be present in a form of metal salt formed by neutralization of 0.01-50% with a base containing metal cation, and the metal cation may be at least one of Li⁺, Na⁺, K⁺, Zn²⁺, Ca²⁺, Co²⁺, Ni²⁺, Cu²⁺, Pb²⁺, and Mg²⁺.

The base may be at least one of formate, acetate, nitrate, carbonate, bicarbonate, oxide, hydroxide, and alkoxide.

In particular, the terpolymers can be obtained from a copolymerization of the monomers a), b) and c), in which the monomer a) is at 15 to 99.98 wt %, the monomer b) at 0.01 to 50 wt %, and the monomer c) at 0.01 to 35 wt %.

The adhesive composition for the adhesive layer comprises may comprise at least one of the additional additives such as polyurethane, polyester, polyamide elastomer, polyamide-ionomer, polyurethane ionomer, thermoplastic ether-ester block copolymer, polycarbonate, polyolefin, polyolefin plastomer, polyamide, copolymeric polyamide, polyvinyl alcohol, acrylonitrile-butadiene-styrene copolymer, polyarylate, polyacrylate, polyphenylene ether, impact-modified polyphenylene ether, high impact polystyrene, diallyl phthalate polymer, styrene-acrylonitrile copolymer, styrene-maleic anhydride polymer, styrenic copolymer, functionalized styrenic copolymer, functionalized styrenic terpolymer, styrenic terpolymer, cellulose-based polymer, liquid crystal polymer, ethylene-propylene-diene terpolymer, ethylene-vinyl acetate copolymer, ethylene-propylene copolymer, ethylene-vinyl acetate, polyurea, and polysiloxane.

In an exemplary embodiment of the present invention, the amount of the additive may be 0.001 to 20 parts by weight based on 100 parts by weight of the adhesive composition, the thickness of the adhesive layer may be 0.001 to 100 mm, and the melting index of the adhesive layer may be 1 g/10 min to 300/10 min.

In an exemplary embodiment of the present invention, the metal layer adhered to the adhesive layer has uneven surface, and the resin layer and the adhesive layer are adhered simultaneously with extrusion.

As above, the present invention provides a metal-resin composite with high shock resistance, thermal shock resistance, and adhesion by using at least one of copolymers and terpolymers which are optimized for the adhesion between metal and resin.

The present invention also provides high adhesion by making the surface of the metal layer uneven and increasing the surface area of the metal layer adhered to the adhesive layer through the unevenness.

Further, the present invention may provide a metal-resin composite with high adhesion and a uniform thickness of the coated adhesive layer by using a twin extruder having two extrusion molds to produce the metal-resin composite.

### BRIEF DESCRIPTION OF DRAWINGS

FIG. 1 is a cross section showing the lamination of the metal-resin composite according to an exemplary embodiment of the present invention.

FIG. 2 is a cross section showing the uneven surface of the metal layer according to an exemplary embodiment of the present invention.

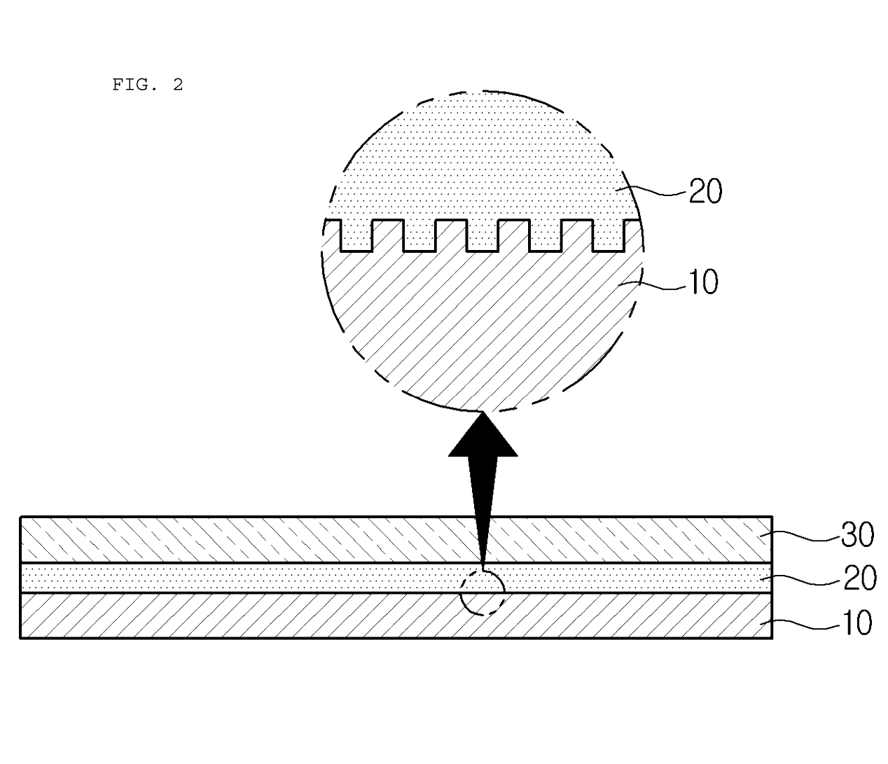

FIG. 3 is a cross section showing the extrusion of resin and adhesion layers using a twin extruder according to an exemplary embodiment of the present invention.

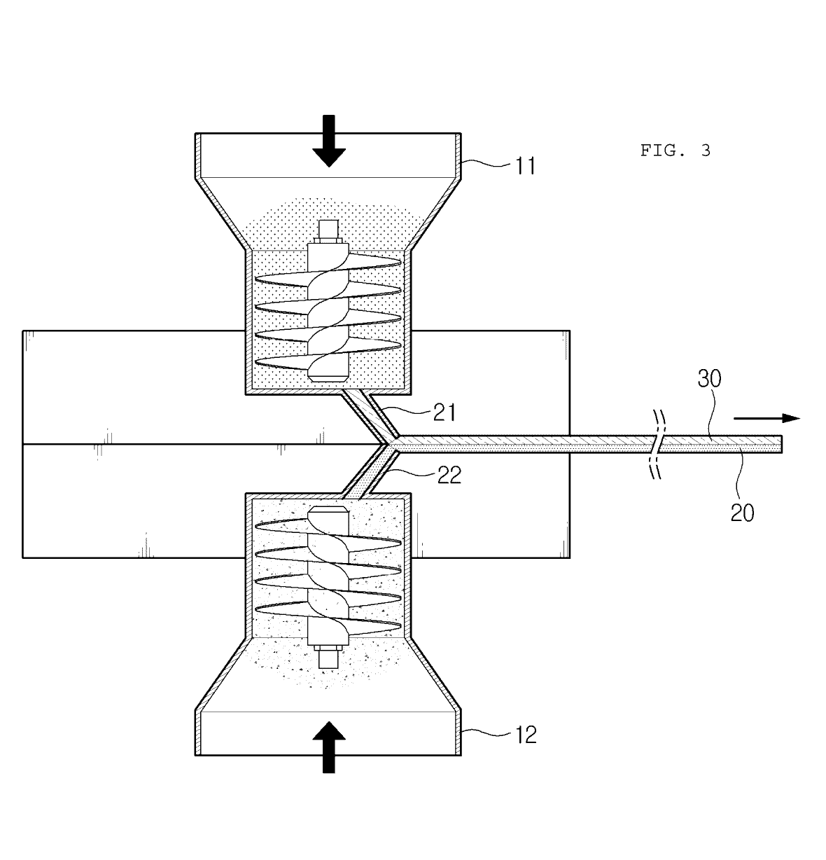

FIG. 4(a) is a photo showing the metal-resin composite produced according to the Comparative Example 1, while FIG. 4(b) is an enlarged photo of FIG. 4(a).

FIG. 5(a) is a photo showing the metal-resin composite produced according to the Comparative Example 2, while FIG. 5(b) is an enlarged photo of FIG. 5(a).

FIG. 6(a) is a photo showing the metal-resin composite produced according to the Example of the present invention, while FIG. 6(b) is an enlarged photo of FIG. 6(a).

### DETAILED DESCRIPTION OF INVENTION

Hereinafter an exemplary embodiment of the metal-resin composite comprising an adhesive layer according to the present invention and its production method will be explained in detail with the aid of attached drawings.

The advantages and characteristics of the present invention, and how to achieve them will be clarified by understanding the examples of embodiment to be set out below together with attached drawings. However, the present invention can be embodied in many forms, not limited to those examples of embodiment to be disclosed below, which are only provided to support the disclosure of the present invention, and to help the ordinary skilled person in the art understand the scope of the invention, which is only defined by the scope of claims. The same reference marks across the specification indicate the same constituents.

Unless otherwise defined, all terms in this specification, including technical and scientific terms, can be used in such a way that can be understood by the ordinary skilled person in the art. Those terms used widely and defined in the dictionary shall not be interpreted abnormally or excessively unless clearly defined in the present disclosure.

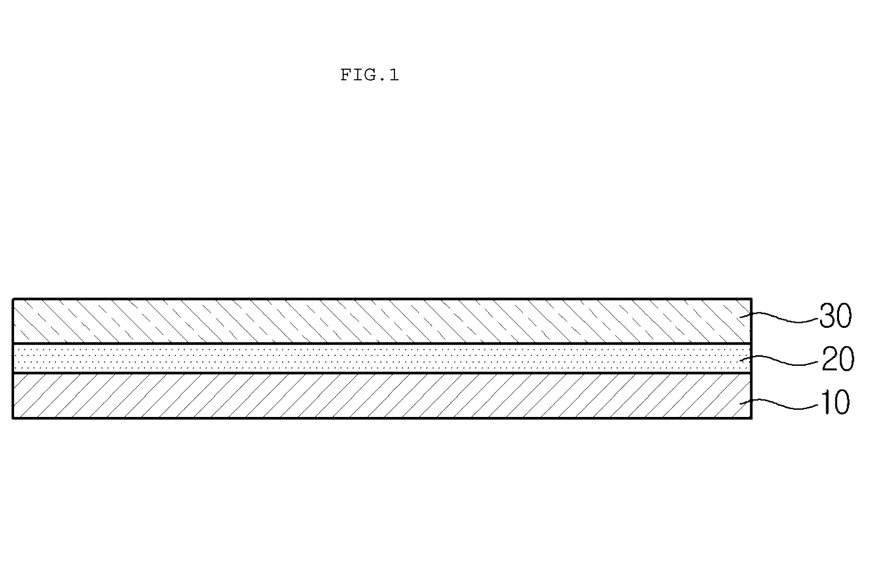

As shown in FIG. 1, a metal-resin composite according to an embodiment of the present invention comprises a metal layer (10) and a resin layer (30), and an adhesive layer (20) between the metal layer (10) and the resin layer (30), and the metal layer (10) and the resin layer (30) are adhered by the adhesive layer (20).

### DESCRIPTION OF REFERENCE MARKS

10: Metal layer;

20: Adhesive layer;

30: Resin layer;

11, 12: Feeding inlet;

21: First slit; and

22: Second slit.

The metals for the metal layer (10) may include any metals that can be bonded to resin, without limitation. For example, aluminum, iron, copper, chrome, nickel, silicon, manganese, tungsten, zinc, magnesium, of an alloy from a combination thereof may be used to improve the durability of the metal-resin composite.

The resins for the resin layer (30) may include any resin that can be laminated to metals, without limitation. In an exemplary embodiment, the resin composition for the resin layer may comprise organic or inorganic filler, wherein the organic filler may include at least one of wood powder, wood pellets, wood fiber and powdered paper, and the inorganic filler may include at least one of talc, calcium carbonate, wollastonite and kaolinite. The organic or inorganic filler provides magnificent appearance if applied, and the resultant metal-resin composite can be used as an exterior material for buildings.

The adhesive layer (20) is positioned between the metal layer (10) and the resin layer (30) to combine both metal layer (10) and resin layer (30) together.

The adhesive layer may be comprised of an adhesive composition which comprises at least one of the copolymers and terpolymers obtained from a copolymerization of two or three of the a), b), c) and d) monomers below.

The monomer a) is an α-olefin represented by the following Chemical Formula 1:

RCH═CH₂ [Chemical Formula 1]

where the substituent R represents a hydrogen or an alkyl radical having 1 to 8 carbon atoms. The use of the copolymers comprising an α-olefin enables the production of the light metal-resin composite.

The monomer b) is an acrylate or methacrylate, preperably methacrylate. The monomer b) serves to prevent cracks from occurring in the metal-resin composite at frequent temperature changes by using the monomer to form a softened copolymer.

The monomer c) is at least one of α,β-ethylenated unsaturated acrylic acid and methacrylic acid each of which has 3 to 20 carbon atoms, sulfonic acid, and phosphoric acid, preferably α,β-ethylenated unsaturated acrylic acid or methacrylic acid.

The monomer d) is a monomer having any one of glycidyl group, hydroxyl group, anhydrous maleic acid group, carboxylic acid group, and ester group.

The polymer contained in the adhesive composition may be preferably a copolymer obtained from a copolymerization of the monomers a) and c), or terpolymer obtained from a copolymerization of the monomers a), b) and c).

The copolymer obtained from a copolymerization of the monomers a) and c) has acid radicals to form ionomers by a reaction with metal salts.

In more detail, the monomer c) can form ionomers through neutralization of 50% or less, preferably 0.01 to 50%, more preferably 10 to 35% by metal salt which is a base containing a metal cation.

If the degree of neutralization exceeds 50%, an ionic cluster is formed by ionic metal salts, and the ionic bonding force increases, which hinders forming, and if below 0.01%, it causes the lack of the metal salts necessary for the required improvement of physical properties.

The metal cation contained in the base may be alkali metal cation, alkali earth metal cation, or transition metal cation with an electrovalence of 2 or less, preferably at least one of Li⁺, Na⁻, K⁺, Zn²⁺, Ca²⁺, Co²⁺, Ni²⁺, Cu²⁺, Pb²⁺, and Mg²⁺, more preferably K⁻ or Zn²⁺.

The metal cation contained in the base serve as a bridge between those polymers formed from the polymerization of the monomers a) and c), and the resulting ionomers have a pseudo-cross-linked structure by the ionic cluster, but a weak ionic bonding force at high temperature to enable melt processing.

And the base is at least one of formate, acetate, nitrate, carbonate, bicarbonate, oxide, hydroxide, and alkoxide, preferably formate or acetate.

The terpolymers formed by a copolymerization of the monomers a), b) and c) may comprise the monomer a) of 15 to 99.98 wt %, the monomer b) of 50 wt % or less (preferably 0.01 to 50 wt %), and the monomer c) of 35 wt % or less (preferably 0.01 to 35 wt %).

If the amount of the monomer c) forming ionomers exceeds 35 wt %, an ionic cluster is formed by ionic metal salts, and consequently the ionic bonding force increases, which hinders the forming process, and if below 0.01%, it causes the lack of the metal salts necessary for the required improvement of physical properties, which makes it difficult to satisfy the shock resistance and thermal shock resistance required for building exterior materials.

The adhesive composition for the adhesive layer may further comprise any conventional additives, which are not limited, if they are widely used in relevant technological fields. The examples of the additives include polyurethane, polyester, polyamide elastomer, polyamide-ionomer, polyurethane ionomer, thermoplastic ether-ester block copolymer, polycarbonate, polyolefin, polyolefin plastomer, polyamide, copolymeric polyamide, polyvinyl alcohol, acrylonitrile-butadiene-styrene copolymer, polyarylate, polyacrylate, polyphenylene ether, impact-modified polyphenylene ether, high impact polystyrene, diallyl phthalate polymer, styrene-acrylonitrile, styrene-maleic anhydride polymer, styrenic copolymer, functionalized styrenic copolymer, functionalized styrenic terpolymer, styrenic terpolymer, cellulose-based polymer, liquid crystal polymer, ethylene-propylene-diene terpolymer, ethylene-propylene copolymer, ethylene-vinyl acetate copolymer, ethylene-vinyl acetate, polyurea, and polysiloxane.

The amount of the additives is 20 parts by weight or less, preferably 0.001 to 20 parts by weight, more preferably 0.1 to 15 parts by weight, based on 100 parts by weight of the adhesive composition, and if it exceeds 20 parts by weight, the amount of copolymers becomes relatively low, resulting in a reduction in physical properties such as adhesion and stability, while if it is less than 0.001 parts by weight, crack prevention efficiency becomes low.

In the metal-resin composite comprising a metal layer (10), an adhesive layer (20) and a resin layer (30), the thickness of the adhesive layer (20) may be 100 mm or less, preferably 0.001 mm to 100 mm, more preferably 1 mm to 50 mm. If the thickness exceeds 100 mm, the metal-resin composite comprising the adhesive layer (20) may have a low workability, while it is below 0.001 mm, it may cause an increase in manufacturing cost and a drastic decrease in adhesion.

The Melt index of the adhesive layer (20) may be 300 g/10 min under the conditions of a temperature of 230° C. and a load of 2.16 kg, preferably 1 g/10 min to 300 g/10 min, more preferably 10 g/10 min to 100 g/10 min, and if it exceeds 300 g/10 min, the adhesive layer may have low uniformity, mechanical properties and thermal shock resistance, while if it is less than 1 g/10 min, the adhesive layer may have low workability.

The metal layer (10) adhered to the adhesive layer (20) may have an uneven surface, and consequently, the surface area of the metal layer (10) in contact with the adhesive composition of the adhesive layer (20) is increased, and thereby an adhesion between them is increased, which helps improve the stability and durability of the metal-resin composite.

A method for manufacturing the metal-resin composite according to an exemplary embodiment of the present invention varies, not limited to certain types, preferably an extrusion process, more preferably a process in which the resin layer is formed by extruding a resin composition for the resin layer through a first slit of a twin extruder, the adhesive layer is formed by extruding an adhesive composition for the adhesive layer through the second slit of the twin extruder, and both of the resin and adhesive layers are adhered together simultaneously with extrusion.

Hereinafter an explanation will be provided to help one understand the present invention with an example of embodiment.

### EXAMPLE 1

A metal-resin composite was manufactured by adhering a metal layer comprising galvanized steel and a resin layer comprising wood powder and talc with an adhesive layer composition comprising a terpolymer obtained from a copolymerization of α-olefin, acrylate and ionomer comprising α,β-ethylenated unsaturated acrylic acid. The resulted metal-resin composite was cooled down for 5 hours at −30° C., and then heated for 5 hours at 60° C., and observed with naked eyes to determine thermal shock resistance.

### COMPARATIVE EXAMPLE 1

A metal-resin composite was manufactured by adhering a metal layer comprising galvanized steel and a resin layer comprising wood powder and talc without using any adhesive. The resulted metal-resin composite was cooled down for 5 hours at −30° C., and then heated for 5 hours at 60° C., and observed with naked eyes to determine thermal shock resistance.

### COMPARATIVE EXAMPLE 2

The same metal and resin layers as those in Comparative Example 1 were used, and a metal-resin composite was manufactured using maleated polyethylene (MAPE) as adhesive layer composition, and observed the resulted metal-resin composite with naked eyes under the same conditions to determine thermal shock resistance.

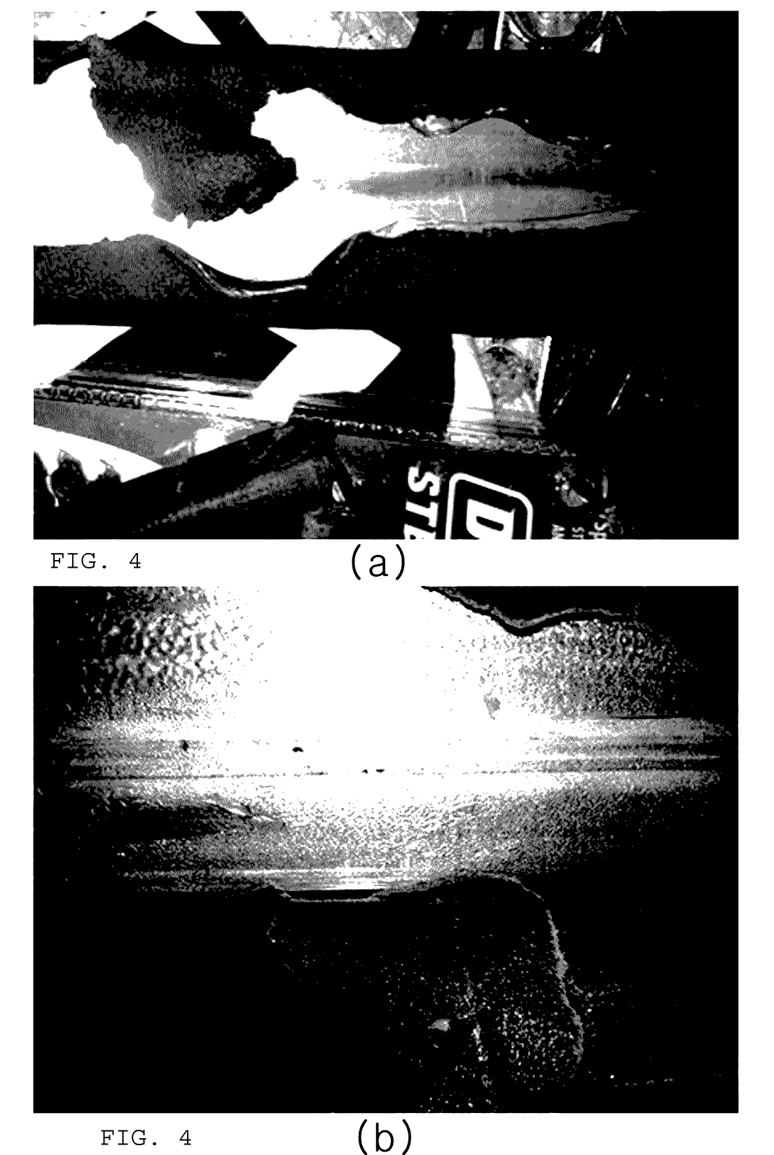

FIG. 4(a) is a photo showing the metal-resin composite manufactured in Comparative Example 1, and FIG. 4(b) is its enlarged photo. They show that the resin and metal layers failed to adhere together during the extrusion process, making it impossible to take a test.

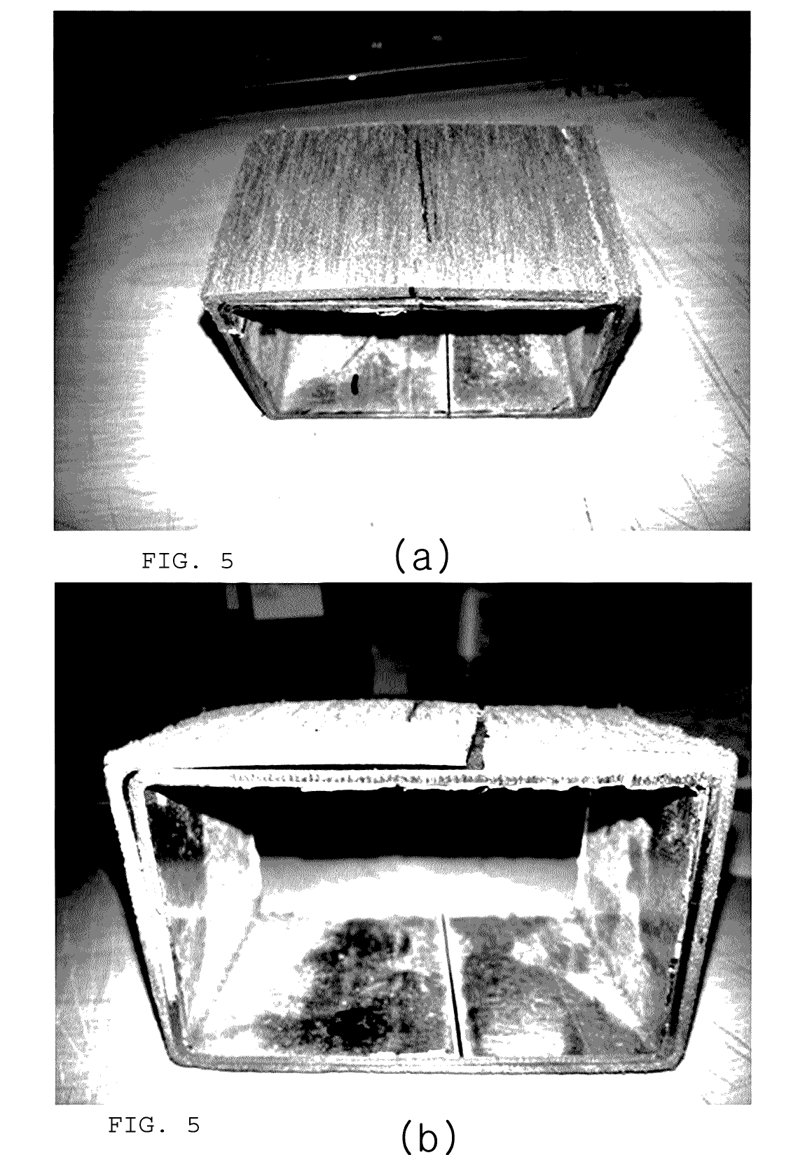

FIG. 5(a) is a photo showing the metal-resin composite manufactured in Comparative Example 2, and FIG. 5(b) is its enlarged photo. They show that although the resin and metal layers adhered together in the extrusion process, cracks were observed on the surface of the resin layer after a thermal shock resistance test.

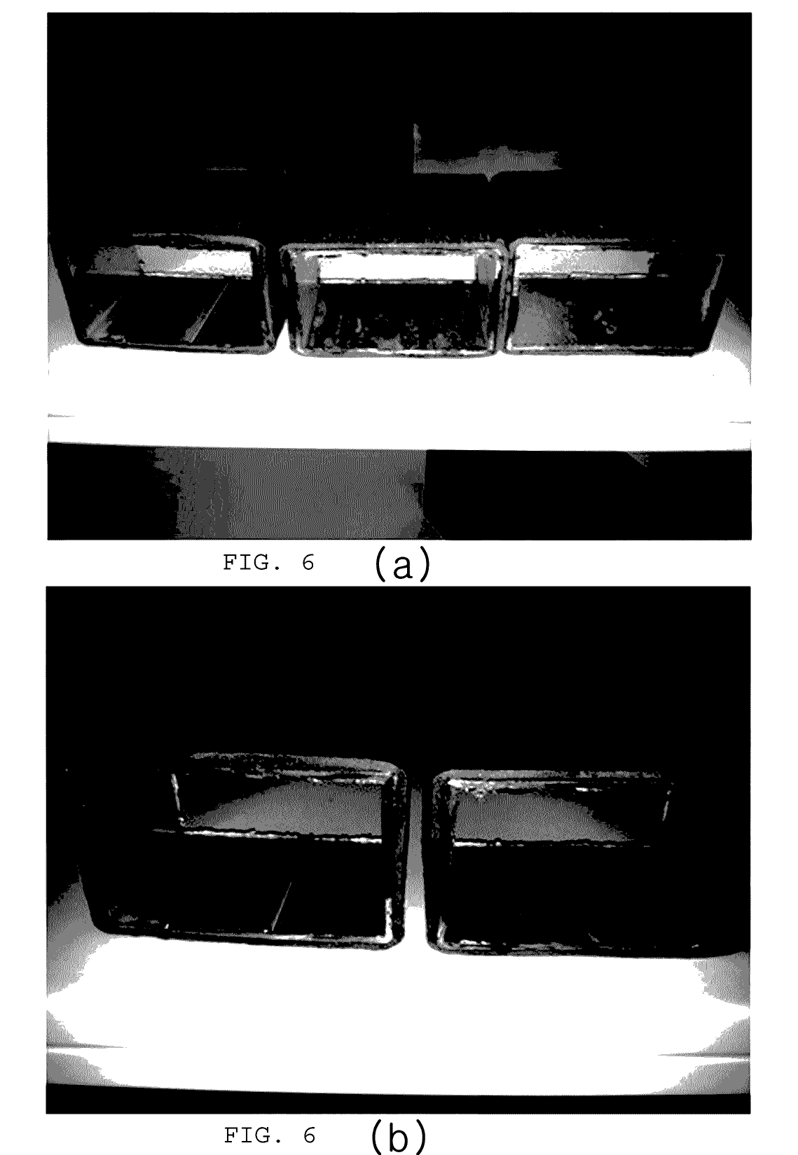

In contrast, FIG. 6(a) is a photo showing the metal-resin composite manufactured in Example 1 according to the present invention, and FIG. 6(b) is its enlarged photo. They show that the resin and metal layers were successfully adhered seamlessly in the extrusion process, and no cracks were observed on the surface of the resin layer after a thermal shock resistance test.

It is therefore to be understood that the present invention is not limited to the particular embodiment disclosed herein, but includes all embodiments falling within the scope of the appended claims. It should also be understood that various changes or modifications may be made by anyone with ordinary skill in the technical field to which the present invention pertains within the scope of the appended claims without departing from the spirit and scope of the present invention.

### INDUSTRIAL APPLICATION

The present invention provides a metal-resin composite comprising an adhesive layer between metal and resin layers, which has enough shock resistance and thermal shock resistance to be available for industrial applications. The adhesive layer comprises at least one of copolymers and terpolymers obtained from a copolymerization of two or three of the following monomers a), b), c) and d):

a) an α-olefin represented by Chemical Formula 1 below:

RCH═CH₂ [Chemical Formula 1]

where R is a hydrogen or an alkyl radical of 1 to 8 carbon atoms; b) at least one of acrylate and methacrylate; c) at least one of α,β-ethylenated unsaturated acrylic acid and methacrylic acid each of which has 3 to 20 carbon atoms, sulfonic acid, and phosphoric acid; and d) a monomer comprising any one of glycidyl group, hydroxyl group, anhydrous maleic acid group, carboxylic acid group, and ester group.

What is claimed is:

1. A metal-resin composite comprising:
a metal layer;
a resin layer; and
an adhesive layer between the metal layer and resin layer,
wherein the adhesive layer comprises an adhesive composition comprising at least one of copolymers and terpolymers obtained from a copolymerization of two or three of the following monomers a), b), c) and d):
a) an α-olefin represented by the following Chemical Formula 1,
RCH═CH₂ [Chemical Formula 1]
wherein R is a hydrogen or an alkyl radical of 1 to 8 carbon atoms;
b) at least one of acrylate and methacrylate;
c) at least one of α,β-ethylenated unsaturated acrylic acid and methacrylic acid each of which has 3 to 20 carbon atoms, sulfonic acid, and phosphoric acid; and
d) a monomer having any one of glycidyl group, hydroxyl group, anhydrous maleic acid group, carboxylic acid group, and ester group.

2. The metal-resin composite of claim 1, wherein the monomer c) is in the form of metal salt neutralized to 0.01%-50% with a base containing metal cation.

3. The metal-resin composite of claim 2, wherein the metal cation is at least one of Li⁺, Na⁺, K⁺, Zn²⁺, Ca²⁺, Co²⁺, Ni²⁺, Cu²⁻, Pb²⁺, and Mg²⁺.

4. The metal-resin composite of claim 2, wherein the base is at least one of formate, acetate, nitrate, carbonate, bicarbonate, oxide, hydroxide, and alkoxide.

5. The metal-resin composite of claim 1, wherein the terpolymer is obtained by a copolymerization of the monomers a), b) and c), and comprises the monomer a) of 15 to 99.98 wt %, the monomer b) of 0.01 to 50 wt %, and the monomer c) of 0.01 to 35 wt %.

6. The metal-resin composite of claim 1, wherein the adhesive composition further comprises at least one of additives selected from polyurethane, polyester, polyamide elastomer, polyamide-ionomer, polyurethane ionomer, thermoplastic ether-ester block copolymer, polycarbonate, polyolefin, polyolefin plastomer, polyamide, copolymeric polyamide, polyvinyl alcohol, acrylonitrile-butadiene-styrene copolymer, polyarylate, polyacrylate, polyphenylene ether, impact-modified polyphenylene ether, high impact polystyrene, diallyl phthalate polymer, styrene-acrylonitrile copolymer, styrene-maleic anhydride polymer, styrenic copolymer, functionalized styrenic copolymer, functionalized styrenic terpolymer, styrenic terpolymer, cellulose-based polymer, liquid crystal polymer, ethylene-propylene-diene terpolymer, ethylene-propylene copolymer, ethylene-vinyl acetate copolymer, ethylene-vinyl acetate, polyurea, and polysiloxane.

7. The metal-resin composite of claim 6, wherein the adhesive composition comprises the additive of 0.001 to 20 parts by weight based on 100 parts by weight of the adhesive composition.

8. The metal-resin composite of claim 1, wherein the adhesive layer has a thickness of 0.001 mm to 100 mm.

9. The metal-resin composite of claim 1, wherein the adhesive layer has a melting index of 1 g/10 min to 300 g/10 min.

10. The metal-resin composite of claim 1, wherein the metal layer adhered to the adhesive layer has an uneven surface.

11. The metal-resin composite of claim 1, the resin layer and the adhesive layer are adhered simultaneously with extrusion.
